(19) United States
(12) Patent Application Publication
(10) Pub. No.: US 2005/0127561 A1
(43) Pub. Date: Jun. 16, 2005

(54) Method of making expandable-collapsible bodies by temperature gradient expansion molding

(75) Inventors: Greg R. Eberl, Sunnyvale, CA (US); The Thomas Trinh Tran, Coon Rapids, MN (US)

Correspondence Address: Bingham McCutchen LLP, Suite 1800, Three Embarcadero, San Francisco, CA, 94111-4067, US

(73) Assignee: Scimed Life Systems, Inc., Maple Grove, MN (US)

(21) Appl. No.: 10/738,112

(22) Filed: Dec. 16, 2003

(51) Int. Cl. B29D 22/00; B29C 55/22; B29C 71/02; B29D 7/00; B28B 11/08; B29C 49/08; B29C 55/00; B29B 17/00; B29C 71/00

(52) U.S. Cl. 264/212; 264/573; 264/291; 264/346

(57) ABSTRACT

A method of making an expandable-collapsible body comprising inflating a precursor body having an exterior surface that is cooler than its interior surface during inflation.

### FIELD OF THE INVENTION

The present invention relates to the field of medical devices, in particular to a method for making expandable-collapsible bodies, such as balloons for use with catheters, using temperature gradient expansion molding.

### BACKGROUND

Expandable-collapsible bodies are used in a variety of medical procedures such as angioplasty where they are used to dilate blood vessels and catheter ablation, where they are used to deliver electric current to regions of the heart to treat tachyarrhythmias.

Expandable-collapsible bodies are currently made using a variety of procedures. One of these is mandrel molding. A mandrel, the external shape and size of which mimics the desired shape and size, in its expanded mode, of the expandable-collapsible body to be created, is dipped one or more times into a solution of the substance from which the expandable-collapsible body is to be formed until a desired wall thickness is achieved. The expandable-collapsible body is allowed to dry on the mandrel and is then removed.

Another current method for forming expandable-collapsible bodies is expansion or blow molding. Here, a precursor body made of a desired substance, e.g., a piece of polyester tubing, is placed into a mold, the inner dimensions of which, like the external dimensions of the mandrel, are the desired size and shape of the expanded mode expandable-collapsible body to be formed. One end of the tube is closed off and a fluid, such as a pressurized gas, is introduced through the open end of the tube, causing it to inflate. The mold is heated or, alternatively, it is ported to permit introduction of a heated fluid. In either case, when the tube comes in contact with the interior surface of the mold or when it contacts the heated fluid it, too, is heated and thereupon softened such that, when brought into contact with the inner surface of the mold, it conforms to its dimensions. The system is then cooled to permanently set the expanded size and shape of the expandable-collapsible body to that of the mold.

In the currently employed expansion molding process described above, the fluid used to inflate the precursor tube is often a gas under control of a constant pressure pump. Under these conditions, some regions of the tube's surface may expand at a different rate due to premature initial yield of the material in some regions compared to others resulting in more rapid expansion in those regions and, therefore, a thinner layer relative to other regions of the product balloon. The thinned-out regions may become so weak that the expanding tube bursts under the inflation pressure before it completely expands to the dimensions of the mold, thereby detrimentally affecting production. More serious is the possibility that a flawed but complete expandable-collapsible body may be formed which then might burst when re-inflated during a procedure in a patient's body.

### SUMMARY OF THE INVENTION

In one embodiment of the invention, a method for making an expandable-collapsible body includes providing a precursor body having an exterior surface and an interior surface that defines a lumen, the lumen describing an axis of the body; providing a mold having an interior surface that defines a selected expanded shape of the expandable-collapsible body to be formed; inserting at least a portion of the precursor body into the mold; immersing the mold containing the precursor body in a first fluid that is at a first temperature such that the first fluid enters the mold and envelops the portion of the precursor body in the mold; inflating the portion of the precursor body that is in the mold until its exterior surface is in intimate contact with the interior surface of the mold, the inflation being carried out by delivering a second fluid, which may be the same as or different than the first fluid and is at a temperature that is higher than the first temperature, into the lumen of the precursor body, expelling the first fluid from the mold; cooling the mold and the newly formed expandable-collapsible body; and, removing the expandable-collapsible body from the mold.

In another embodiment of the invention, a method for making an expandable-collapsible body includes providing a precursor body having an exterior surface and an interior surface that defines a lumen, the lumen describing an axis of the body; immersing the precursor body in a first fluid that is at a first temperature; inflating the precursor body by delivering a second fluid, which may be the same as or different than the first fluid, into the lumen of the precursor body, the second fluid being at a second temperature that is higher than the first temperature; and, after the precursor body has been inflated to a desired size, cooling the newly formed expandable-collapsible body.

By way of non-limiting examples, the first and second fluids may be is air or a liquid (e.g., water) that is compatible with the precursor body. In one embodiment, the second fluid is a liquid and inflation comprises controlled volumetric metering of the second fluid into the lumen of the precursor body.

In one embodiment, the second temperature is at least 20° C. higher than the first temperature. In another embodiment, the second temperature is at least 40° C. higher than the first temperature.

In one embodiment, the formed expandable-collapsible body is annealed at a temperature that is higher than a maximum projected use temperature.

In embodiments of the invention, the precursor body may be natural or synthetic, crystalline, semi-crystalline or amorphous polymer, wherein the polymer may or may not be elastomeric and/or the polymer may or may not be partially cross-linked and/or the polymer may or may not be cross-linkable after expansion. By way of non-limiting example, the precursor body may be a polyurethane.

In embodiments invention, the method may further comprise stretching the precursor body along the axis described by the lumen to a degree that results in a length that is 25% to 300% greater than its original length. In one embodiment, the precursor body is stretched to a degree that results in a length that is 50% to 100% greater than its original length. In one embodiment, stretching comprises softening a region of the precursor body that is to be stretched, applying a force to the softened region in a direction parallel to the axis until a desired degree of stretching has been achieved and cooling the softened region to stabilize it. In embodiments of the invention, the region may be uniformly softened resulting in a uniform degree of stretching. Alternately, the region may be selectively softened resulting in a variable degree of stretching.

The invention further includes expandable-collapsible bodies made by the inventive methods taught herein.

Other aspects and features of the invention will be evident from reading the following detailed description of the illustrated embodiments, which are provided to illustrate, not limit, the invention.

### BRIEF DESCRIPTION OF THE FIGURES

The method of this invention is described by reference to devices and systems that can be used to carry it out as shown in the accompanying Figures. It is to be understood that the Figures and the devices and systems depicted therein are provided by way of illustration only and are not intended, not are they to be construed, as limiting the scope of this invention in any manner whatsoever. Those skilled in the art will recognize numerous other devices and systems that can or might be usable with the method of this invention based on the disclosures herein; use of the method with any and all such devices and systems is within the scope of this invention.

FIG. 1 is a schematic representation of a system that can be used to make an expandable-collapsible body using the method of this invention.

FIG. 2 is a schematic representation of an alternative approach to providing an inflating fluid in the system of FIG. 1.

FIG. 3 shows a partially inflated precursor body in the mold of the system of FIG. 1.

### DISCUSSION

Methods of the invention begin with a “precursor body” from which an expandable-collapsible body will be created. As used herein, a precursor body comprises a mass of a selected substance having an exterior surface and an interior surface that describes a lumen. The lumen itself describes an axis of the precursor body that is essentially perpendicular to the direction of eventual expansion. This is most easily envisioned by considering a precursor body that is a piece of polymeric tubing, a non-limiting embodiment of this invention. When the inner surface that describes the lumen is subjected to pressure, it expands, the surface moving outward perpendicular to a center line, or axis, of the lumen. Of course, the precursor body can have any desired shape, the only limitation being that it must be capable of being inflated without bursting when using methods according to the present invention.

As noted above, an exemplary shape is an elongate segment of tubing made of the substance from which the expandable-collapsible body is to be created. However, the precursor body may also have a different predetermined shape. A non-limiting example of a different shape is a tube having varying cross-sectional diameters along its length, such that it has an undulating outer surface having the appearance of an hour-glass. Other precursor body shapes will become apparent to those skilled in the art based on the disclosures herein and all such shapes are within the scope of this invention.

Precursor body substances include, without limitation, natural or synthetic crystalline, semi-crystalline or amorphous polymers that may or may not be elastomeric. The polymers may be partially cross-linked or of such a nature that they are cross-linkable after formation of the expandable-collapsible body. Examples, again without limitation, of such polymers include polyurethane, regenerated cellulose, nylon, polycarbonate, polytetrafluoroethylene (PTFE), polyethersulfone, modified acrylic copolymers, cellulose acetate, polyester, polyethylene, and polypropylene. The polymer of which the precursor body is made may, if desired, include fillers such as electrically conductive materials, for example without limitation, metals or conductive salts, strengthening materials such as, without limitation, carbon fibers, and the like. Virtually any filler that does not adversely affect the physical characteristics of the precursor body during inflation or those of the final expandable-collapsible body may be used. Determination of whether a desired filler is or is not acceptable will be readily ascertainable by those skilled in the art without undue experimentation; thus, the use of any and all such fillers is within the scope of this invention.

A precursor body may also be made of two or more layers of substances, so long as the substances are compatible with regard to their ability to expand to the desired final size and shape under the inflation force applied during the process. A non-limiting example of such a layered precursor body would be a hydrophilic conductive substance over-laid with a hydrophobic non-conductive substance wherein the substances have compatible physical properties. After the precursor body is expanded, the outer, non-conductive layer can be selectively removed in a predetermined pattern to provide a finished product that is conductive in certain regions on its surface and non-conductive in others. Other types of layered precursor bodies will become apparent to those skilled in the art based on the disclosures herein and are within the scope of this invention.

The precursor body may be stretched along the axis described by its lumen prior to inflation. In general, a precursor body may be stretched to a length of from 25% to 300% greater than its initial length, with 50% to 100% being presently preferred for the present invention The stretching may be uniform or it may be variable.

One manner of stretching a precursor body is to first soften it, usually by warming, then to stretch it to the desired degree and, finally, to cool it to stabilize it. The temperature to which the precursor body is warmed depends on the characteristics of the substance of which it is made and will be readily determinable by those skilled in the art. A temperature for cooling/stabilization is preferably less than 10° C., and less than 5° C. in certain embodiments. If the entire region to be stretched of a precursor body is warmed to essentially the same temperature and then is stretched, uniform stretching will result, that is, at each point along the region being stretched, the degree of stretching will be essentially the same. However, if desired, selective softening can be employed. Certain regions of the precursor body may be insulated against warming or may even be actively cooled such as with a cooling collar or cooling spray while other regions are being warmed. When a stretching force is applied to the region, the warmed portions will stretch while the cooler regions will either stretch less or not at all, thus resulting in a variable degree of stretching. The process may be repeated as much as desired, alternatively warming and cooling different regions of a precursor body, subjecting it to a stretching force, cooling it to stabilize it and then repeating the sequence until the desired degree of stretch in each portion of the precursor body region being stretched is achieved.

Without being bound to any particular theory, it is believed that stretching the precursor body results in orientation of the polymer in the direction of stretching which has the effect of enhancing processibility and strength of the precursor body and the final expanded version thereof. Later, when the body is expanded/inflated (the terms are used interchangeably herein), the polymer will be oriented in the direction of expansion, which, as noted above, is essentially perpendicular to the axis defined by the lumen, which was the direction of initial stretching. This results in the polymer becoming bi-axially oriented, an even more favorable condition for a polymer where strength and dimensional stability are desired characteristics of the construct being formed from the polymer.

Two fluids are used in the described embodiments of this invention, one will be referred to as the “immersion fluid” and the other as the “expansion fluid.” The fluids may be the same or different. The immersion fluid is one in which the precursor body is initially bathed and which is in contact with the outer surface of the precursor body during inflation. The expansion fluid is delivered into the lumen of the precursor body at the appropriate time, discussed below, to inflate the body to form an expandable-collapsible body.

As used herein, a “fluid” refers generally to a gas or a liquid, wherein “liquid” includes a substance that is a solid at ambient temperature but liquefies at the temperature at which it is being used in the described method of this invention. That a fluid must be “compatible with the precursor body” means that the fluid will not adversely affect the substance of which the precursor body is made. Adverse effects include anything that might interfere with the formation of the expandable-collapsible body or with its strength once formed such as a liquid that the precursor body substance is to some extent soluble in or that can react with the precursor body substance to form a different substance that would result in an expandable-collapsible body having inferior physical properties. Water is generally compatible with virtually any substance that might be used in the method of this invention, and may be used for use both as an immersion fluid and as an expansion fluid. Those skilled in the art will, however, have no difficulty ascertaining without undue experimentation whether a fluid is or is not compatible with a particular precursor body substance; thus, any substance/fluid combination that is compatible is within the scope of this invention.

In one embodiment of this invention, the expansion fluid is a gas and a constant pressure pump be used to effect expansion. However, as noted previously, when a gas is used in constant pressure mode, uneven expansion may occur as the result of, e.g., slight differences in the thickness of the precursor body that in turn result in premature initial yield and expansion, which, if unchecked, result in the over-expansion of the precursor body in that/those region(s) and ultimately bursting. As such, it may be preferred that the expansion fluid be a liquid rather than a gas. Liquids are non-compressible so that inflation of a precursor body can be precisely controlled using volumetrically-controlled (or, synonymously, “controlled volumetric”) delivery of a predetermined quantity of a liquid into the precursor body lumen, thus eliminating the possibility of displacement/volume fluctuations and concurrent benefits in terms of production reliability and consistency and final product characteristics.

Once the expansion fluid source is attached to the lumen of the precursor body, the body is immersed in the immersion fluid, which, as noted previously, may be the same as, or different than, the expansion fluid. By “immersed” is meant that the precursor body is completely surrounded by the fluid. Thus, the body may be submerged in water, in one embodiment, or in some other liquid or it may placed in an oven, where it would be “immersed” in heated air, air being a fluid as defined herein, or it may simply be left exposed to, and “immersed in,” air at ambient temperature. Of course, if the immersion fluid is a gas, gases other than air may be used.

The precursor body may be left in the immersion fluid until it has essentially equilibrated to the temperature of the immersion fluid or the next step may be instituted immediately. It is, however, preferred that the body be left in the immersion fluid at least long enough that a layer of the precursor body adjacent to its exterior surface has had time to equilibrate to the immersion fluid temperature.

Once the precursor body is at the temperature of the immersion fluid and a source of expansion fluid has been connected to one end of it, expansion fluid is delivered into the lumen to purge any air that might be trapped therein. Then the end of the precursor body opposite that where the expansion fluid source is attached is closed off. As noted previously, the expansion fluid may be the same as, or different than, the immersion fluid. The difference is that the expansion fluid is at a higher temperature than the immersion fluid. While any temperature difference can be used, it is preferred that the expansion fluid be at least about 10° C., more preferably at least about 20° C., and still more preferably at least about 40° C. higher than that of the immersion fluid. The exact temperature of the two fluids will depend on the substance of which the precursor body is made. The selected temperatures will create a temperature gradient in the wall of the precursor member such that (a) the immersion fluid will cause slight to moderate softening of the outer surface/layer of the precursor body to facilitate overall expansion but still leave the outer surface/layer with enough toughness and structural integrity to withstand the force of expansion and (2) the expansion fluid will cause the inner surface/layer of the precursor body to be softened to a substantially greater degree than the outer surface/layer so that the overall resistance of the precursor body to inflation is reduced thus reducing the force required to effect inflation. In this manner the chances of the precursor body bursting during expansion are greatly diminished as is the chance of uneven expansion resulting in a fully formed but structurally flawed expandable-collapsible body.

Appropriate immersion fluid and expansion fluid temperatures for use with the method herein will be readily ascertainable without undue experimentation by those skilled in the art based on the disclosure herein. Any combination of temperatures that results in the above relationship between the physical characteristics of the outer surface/layer and inner surface/layer of a precursor body made of any selected substance is within the scope of this invention.

Once the precursor body has been expanded to the desired dimensions, any number of procedures well-known in the art may be employed. The newly formed expandable-collapsible body may be allowed to equilibrate to the temperature of the immersion bath or the immersion bath may be heated to the temperature of the expansion fluid or, if desired an even higher temperature, and the newly-formed expandable-collapsible body allowed to equilibrate at that temperature. If desired, the temperature can be adjusted to anneal the expandable-collapsible body at a temperature that is above its projected use temperature. For example, if the expandable-collapsible body is to used as an angioplasty balloon, then it would be annealed at a temperature above body temperature. If, on the other hand, the expandable-collapsible body is to be used as an ablation balloon, the annealing temperature would be dictated by the temperature expected to be generated during the ablation procedure. In general, however, whatever elevated temperature protocols are applied to the newly-formed expandable-collapsible body, it is eventually cooled, while still inflated with expansion fluid, to a temperature that will permanently set the expanded size/shape of the expandable-collapsible body. Appropriate temperatures for setting the shape of the expandable-collapsible body will, again, depend on the substance from which it is formed. Such temperatures will be apparent to those skilled in the art based on the disclosures herein. As before, any combination of substance and setting temperature is within the scope of this invention.

### ILLUSTRATED EXAMPLE

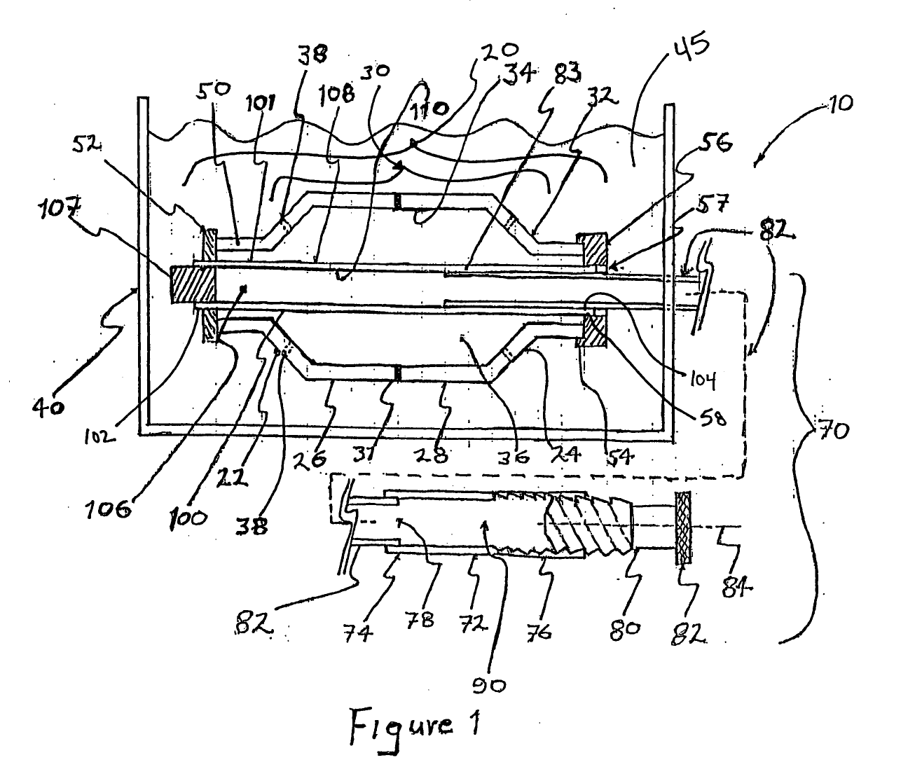

The example that follows comprises an exemplary embodiment of this invention, that is, the use of a piece of tubing as the precursor body and an expansion mold to define the expanded shape and size of the expandable-collapsible body to be formed. The example will be described in conjunction with the system shown in FIG. 1. It is also understood that the Figures are not drawn to scale and that they are provided solely to aid in the understanding of the invention and are not intended, nor are they to be construed, as being exhaustive or limiting on the scope of this invention in any manner whatsoever. That is, the system shown is but one of a large number of systems that could be used with the method of this invention and the individual devices that make up the described system are also amenable to great variation, all of this without affecting the method hereof. All such variations in the system and/or devices are within the scope of this invention. For the purposes of this example the tubing will be assumed to be made of polyurethane.

System 10 of FIG. 1 includes a mold 20, a expansion fluid delivery device 70, a lumen plug 107 and a controlled environment unit (“container”) 40, filled with an immersion fluid 45, in this case water.

Mold 20 is comprised of a first portion 22 having an enlarged proximal end 26, and a second portion 24 having an enlarged distal end 28. Proximal end 26 is configured to mate with distal end 28 to form mold 20 which defines a void 36 having the size and shape of the expandable-collapsible body to be created. As shown in FIG. 1, first portion 22 is secured to second portion 24 by a thread mechanism 31. Other mechanisms such as, without limitation, snap-fit, frictional or luer-lock connectors or compressive support devices may also be used to secure the first and second portions. Mold 20 has an exterior surface 32 and an interior surface 34 that defines void 36. Mold 20 also includes one or more openings 38 through which a fluid may escape void 36 during use. Mold 20 also includes a clamp 52 secured to distal end 50 of first portion 22 and a locking device 56 coupled to proximal end 54 of second portion 24. Alternatively, locking device 56 may be part of fluid delivery device 70. Void 36 of mold 20 is, of course, not limited to the shape illustrated in FIG. 1; any desired shape (and size) conforming to that of the desired expandable-collapsible body can be used. Mold 20 can be made from virtually any material that can withstand the temperatures of the method hereof such as, without limitation, metals, alloys or plastics.

Fluid delivery device 70 includes a threaded tubular member 72 having a distal end 74, a proximal end 76, and a lumen 78 extending between the distal and proximal ends. Fluid delivery device 70 also includes a plunger 80 at least partially disposed within lumen 78 at proximal end 76 of tubular member 72 and a tube 82 connecting distal end 74 of tubular member 72 to proximal end 54 of second portion 24. Plunger 80 is threaded and can be screwed into tubular member 72 by turning handle 82 about axis 84. Alternatively, a friction-type plunger that can be advanced by simply pushing on handle 82 can be used.

Fluid delivery device 95 may also comprise a pump (FIG. 2) instead of the plunger mechanism of FIG. 1. In FIG. 2, fluid delivery device 95 includes a pump 86 connected to a container 88 of fluid 90 and to tube 82. Pump 86 is variable pressure-limited and under volumetric control, and is used to deliver fluid 90 through tube 82 to lumen 106 of precursor body 100.

Precursor body 100 is an elongate segment of tubing having a distal end 102, a proximal end 104, an exterior surface 108, an interior surface 110 and a lumen 106 extending between the distal and proximal ends.

Prior to being placed in mold 20, precursor body 100 is stretched along its longitudinal axis to approximately twice its initial length (a 100% stretch) Stretched precursor body 100 is placed in mold 20 and expansion fluid delivery tube 82 is inserted into end 104. While FIG. 1 shows tube 82 inserted into precursor body 100 until distal end 83 is approximately halfway along the length of precursor body 100, anywhere within lumen 106 is acceptable. After tube 82 is positioned, locking device 56 is used to close off proximal end 104 of precursor body 100 such that a fluid being delivered into lumen 106 cannot escape through that end of the body. In FIG. 1, locking device 56 is a friction-type connector that includes an opening 57. Opening 57 has a cross-sectional dimension that is slightly larger than the cross-sectional dimension of tube 82, such that when locking mechanism 56 is closed down around proximal end 104, an interior surface 58 of locking mechanism 56 compresses proximal end 104 against the exterior surface of tube 82.

The assembled system is then placed in container 40, which has been filed with water 45 in this example. The water 45 can be at any temperature from about 20° C. to about 60° C. but, when precursor body 100 is polyurethane, approximately 45° C. is presently preferred. Mold 20 and precursor body 100 are then allowed to equilibrate to the temperature of the water bath.

Once mold 20 and precursor 100 have equilibrated at the temperature of the water bath, water at a temperature higher than the temperature of the bath, preferably from about 20° C. to about 40° C. higher, is delivered into lumen 106 to expel any air that may have been trapped there through distal end 102 of precursor body 100. It is presently preferred that the water be about 85° C.; i.e., 40° C. higher than the immersion bath temperature of 45° C. After air has been expelled from lumen 106, distal end 102 is closed off using lumen plug 107, although any manner of closure such as, without limitation, a screw-clamp or spring clamp may be used.

After both ends of precursor body 100 are sealed, the body may be allowed to equilibrate for a period, say 1 to 2 minutes, if desired before further advancing the plunger 80.

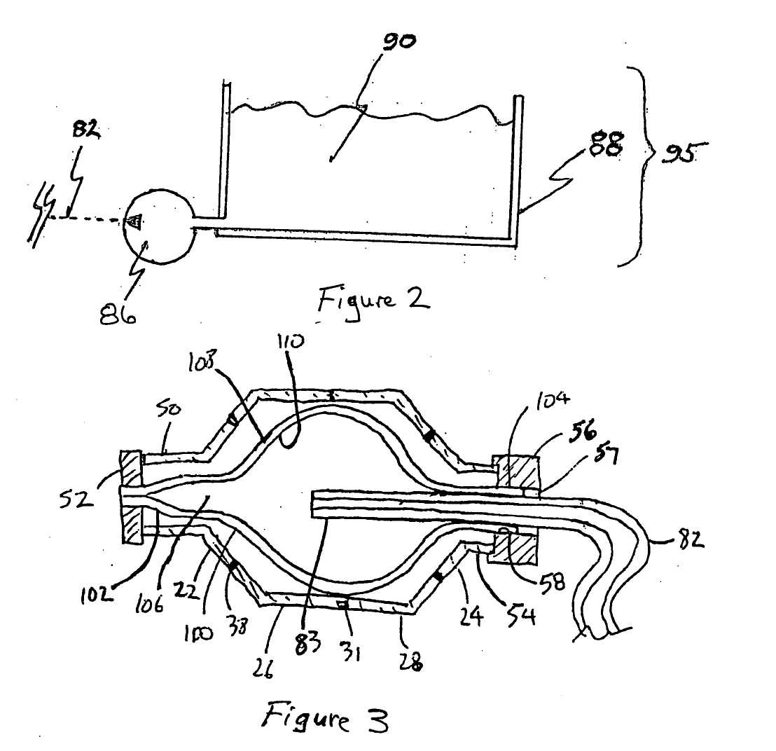

Plunger 80 is advanced to deliver more water into lumen 106 thereby causing precursor body 100 to expand. FIG. 3 shows precursor body 100 partially expanded inside mold 20.

Once sufficient water has been introduced into the lumen of precursor body 100 to cause it to expand until outer surface 108 is in intimate contact with inner surface 34 of mold 20, the temperature of the exterior surface 108 needs not remain below the temperature of the interior surface 110. For example, after body 100 has expanded, it can be heated further in an annealing or heat-setting process, in which the entire newly-formed expandable-collapsible body is equilibrated to one temperature to produce desired expandable-collapsible properties.

After the expandable-collapsible body has been formed in mold 20, the mold is cooled to set the created shape. For example, mold 20 is placed in a cooling fluid, such as water, in a refrigerator, or adjacent to a cooling fan. In the present Example, where the expandable-collapsible body is polyurethane. it is placed in a cooling water bath that is below 10° C., and more preferably, below 6° C. and left there for approximately 2 minutes. After the newly-formed shape is set, the first portion 22 of the mold 20 is uncoupled from second portion 24 of the mold 20 to retrieve the expandable-collapsible body.

If desired, rather than, or in addition to, using a cooling bath, the fluid delivery device 70 or 95 is also used to deliver cooling fluid into lumen 106 of expanded precursor body 100 to cool at least its interior surface 110 while maintaining a pressure within the lumen 106 of the member 100. Other methods of cooling or setting the inflated member 100 can also be used.

After the expandable-collapsible body has been formed, it can be further processed if desired. For example, without limitation, it can be rendered porous if desired by use of a CO₂ laser, eximer laser, YAG laser, high power YAG laser, electronic particle bombardment, and the like. Also, coatings or other surface treatments can be applied to the expandable-collapsible body to, for example without limitation, render its surface more hydrophilic, to improve its electrical properties or to reduce its coefficient of friction.

It will be apparent to those skilled in the art that many changes and modifications may be made in the method described herein without departing from the scope of the invention and all such modifications are within the scope of this invention, as defined in the following claims.

1. A method for making an expandable-collapsible body, comprising:
providing a precursor body having an exterior surface and an interior surface that defines a lumen, the lumen describing an axis of the body;
providing a mold having an interior surface that defines a selected expanded shape of the expandable-collapsible body to be formed;
inserting at least a portion of the precursor body into the mold;
immersing the mold containing the precursor body in a first fluid that is at a first temperature such that the first fluid enters the mold and envelops the portion of the precursor body in the mold;
inflating the portion of the precursor body that is in the mold until its exterior surface is in intimate contact with the interior surface of the mold, the inflation being carried out by delivering a second fluid, which may be the same as or different than the first fluid and is at a temperature that is higher than the first temperature, into the lumen of the precursor body, expelling the first fluid from the mold;
cooling the mold and the newly formed expandable-collapsible body; and,
removing the expandable-collapsible body from the mold.

2. The method of claim 1, further comprising stretching the precursor body along the axis described by the lumen to a degree that results in a length that is 25% to 300% greater than its original length.

3. The method of claim 2, wherein stretching comprises:
softening a region of the precursor body that is to be stretched;
applying a force to the softened region in a direction parallel to the axis until a desired degree of stretching has been achieved; and,
cooling the softened region to stabilize it.

4. The method of claim 3, wherein the region is uniformly softened resulting in a uniform degree of stretching.

5. The method of claim 3, wherein the region is selectively softened resulting in a variable degree of stretching.

6. The method of claim 2, wherein the precursor body is stretched to a degree that results in a length that is 50% to 100% greater than its original length.

7. The method of claim 6, wherein the degree of stretching of the precursor body is uniform along the axis.

8. The method of claim 6, wherein the degree of stretching of the precursor body is variable along the axis.

9. The method of claim 1, wherein the first fluid is air.

10. The method of either claim 9, wherein the second fluid is air.

11. The method of 9, wherein the second fluid is a liquid that is compatible with the precursor body.

12. The method of claim 1, wherein the first fluid is a liquid that is compatible with the precursor body.

13. The method of claim 12, wherein the second fluid is air.

14. The method of claim 12, wherein the second fluid is a liquid that is compatible with the precursor body.

15. The method of claim 1, wherein the first and second fluids are each water.

16. The method of claim 1, wherein the second temperature is at least 20° C. higher than the first temperature.

17. The method of claim 1, wherein the second temperature is at least 40° C. higher than the first temperature.

18. The method of claim 1, wherein the second fluid is a liquid and inflation comprises controlled volumetric metering of the second fluid into the lumen of the precursor body.

19. The method of claim 1, further comprising annealing the formed expandable-collapsible body at a temperature that is higher than a maximum projected use temperature.

20. The method of claim 1, wherein the precursor body comprises a natural or synthetic, crystalline, semi-crystalline or amorphous polymer, and wherein
the polymer may or may not be elastomeric,
the polymer may or may not be partially cross-linked, and
the polymer may or may not be cross-linkable after expansion.

21. The method of claim 20, wherein the precursor body comprises a polyurethane.

22. A method for making an expandable-collapsible body, comprising:
providing a precursor body having an exterior surface and an interior surface that defines a lumen, the lumen describing an axis of the body;
immersing the precursor body in a first fluid that is at a first temperature;
inflating the precursor body by delivering a second fluid, which may be the same as or different than the first fluid, into the lumen of the precursor body, the second fluid being at a second temperature that is higher than the first temperature, and,
after the precursor body has been inflated to a desired size, cooling the newly formed expandable-collapsible body.

23. The method of claim 22, further comprising stretching the precursor body along the axis described by the lumen to a degree that results in a length that is 25% to 300% greater than its original length.

24. The method of claim 23, wherein the degree of stretching of the precursor body is uniform along the axis.

25. The method of claim 23, wherein the degree of stretching of the precursor body is variable along the axis.

26. An expandable-collapsible body made by the method of claim 1.

27. An expandable-collapsible body made by the method of claim 22.
